(19) United States
(12) Patent Application Publication
(10) Pub. No.: US 2016/0301347 A1
(43) Pub. Date: Oct. 13, 2016

(54) Hybrid Hard Chopping and Soft Chopping Current Regulation

(71) Applicant: Caterpillar Inc., Peoria, IL (US)

(72) Inventors: Jesse Gerdes, Dunlap, IL (US); Jackson Wai, Dunlap, IL (US); Ahmed Khalil, Peoria, IL (US); Ernesto Inoa, Dunlap, IL (US); Carlos Nino Baron, Edwards, IL (US)

(73) Assignee: Caterpillar Inc., Peoria, IL (US)

(21) Appl. No.: 14/683,610

(22) Filed: Apr. 10, 2015

(51) Int. Cl. H02P 25/08

(52) U.S. Cl. CPC H02P 25/08

(57) ABSTRACT

A method of regulating a phase current of an electric motor is provided. The method may include selectively enabling one or more switches of each phase of the electric motor according to one of at least a soft chopping motoring routine and a soft chopping generating routine, monitoring the phase current relative to at least one limit of a hysteresis band and a switching period, and controlling the switches according to a hard chopping routine when the phase current does not reach the limit within the switching period.

### TECHNICAL FIELD

The present disclosure relates generally to electric generators and electric motors, and more particularly, to systems and methods of regulating phase current in switched reluctance machines.

### BACKGROUND

Electric generators are often used to convert mechanical power received from a primary power source, such as a combustion engine, into electrical power for powering one or more loads of a work machine. Electric motors can be used to convert electrical power within a common bus or storage device into mechanical power, such as rotational power for driving wheels, tracks or other traction devices. Furthermore, electric motors can also be used to convert mechanical power received through traction devices, such as during regenerative braking, into electrical power for storage or use by other loads. Among the various types of electric machines available, switched reluctance machines have received increased interest for being robust, cost-effective, and generally more efficient. While various systems and methods for controlling switched reluctance machines are currently available, there is still room for improvement.

Typical control schemes for switched reluctance machines may involve operating two switches of each phase of the stator in one of two general operating modes, for example, single pulse and current regulation modes of operation. Single pulse modes are used for higher operating speeds, while current regulation modes are used for nominal or lower operating speeds. As disclosed in U.S. Pat. No. 6,922,036 (“Ehsani”), for example, current regulation modes for nominal operating speeds may be operated by hard chopping current to the two switches of each phase, while current regulation modes for relatively low operating speeds may be operated by soft chopping current to the two switches of each phase.

Hard chopping is provided by simultaneously opening and closing both switches of each phase at the appropriate frequency, whereas soft chopping is provided by holding one of the two switches in either an opened or closed state while opening and closing the second switch at the appropriate frequency, thereby providing for zero-voltage loops. Operating switches according to conventional hard chopping routines at low operating speeds or during regenerative braking may produce phase currents that are more reliably within the desired current band. However, this is achieved at the cost of high switching frequencies and substantial stress on the converter circuit, which further limit the amount of time hard chopping can be used. Applying soft chopping routines exerts less stress on the converter circuit than with hard chopping, but phase currents during the zero-voltage loops of soft chopping routines do not always respond as desired.

The present disclosure is directed at addressing one or more of the deficiencies and disadvantages set forth above. However, it should be appreciated that the solution of any particular problem is not a limitation on the scope of this disclosure or of the attached claims except to the extent express noted.

### SUMMARY OF THE DISCLOSURE

In one aspect of the present disclosure, a method of regulating a phase current of an electric motor is provided. The method may include selectively enabling one or more switches of each phase of the electric motor according to one of at least a soft chopping motoring routine and a soft chopping generating routine, monitoring the phase current relative to at least one limit of a hysteresis band and a switching period, and controlling the switches according to a hard chopping routine when the phase current does not reach the limit within the switching period.

In another aspect of the present disclosure, a control system for regulating a phase current of an electric motor is provided. The control system may include a converter circuit operatively coupled to a stator of the electric motor, and a controller in communication with each of the electric motor and the converter circuit. The converter circuit may include one or more switches coupled to each phase of the stator. The controller may be configured to enable the switches of each phase of the stator according to one of at least a soft chopping motoring routine and a soft chopping generating routine, monitor the phase current relative to at least one limit of a hysteresis band and a switching period, and control the switches according to a hard chopping routine when the phase current does not reach the limit within the switching period.

In yet another aspect of the present disclosure, an electric drive is provided. The electric drive may include an electric motor having a rotor and a stator, a converter circuit in communication with the stator, and a controller in communication with each of the stator and the converter circuit. The converter circuit may include at least a first switch and a second switch coupled to each phase of the stator. The controller may be configured to enable the first switch and the second switch according to one of at least a soft chopping motoring routine and a soft chopping generating routine, monitor the phase current relative to at least one limit of a hysteresis band and a switching period, and control the first switch and the second switch according to a hard chopping routine when the phase current does not reach the limit within the switching period.

### BRIEF DESCRIPTION OF THE DRAWINGS

FIG. 1 is a diagrammatic view of one exemplary machine having an electric drive constructed in accordance with the teachings of the present disclosure;

FIG. 2 is a schematic view of one exemplary control system for an electric drive having a switched reluctance generator;

FIG. 3 is a schematic view of one exemplary control system for an electric drive having a switched reluctance motor;

FIG. 4 is a flowchart of one exemplary method of controlling a switched reluctance machine;

FIG. 5 is a graphical view of operating a switched reluctance machine using a hard chopping routine;

FIG. 6 is a graphical view of operating a switched reluctance machine using a soft chopping generating routine;

FIG. 7 is a graphical view of operating a switched reluctance machine using a soft chopping motoring routine;

FIG. 8 are graphical views of phase current and bus voltage illustrating hybrid hard-soft chopping motoring routines;

FIG. 9 are graphical views of phase current and bus voltage illustrating hybrid hard-soft chopping generating routines; and

FIG. 10 is a graphical view of operating a switched reluctance machine at relatively low operating speeds using a hybrid hard-soft chopping routine.

### DETAILED DESCRIPTION

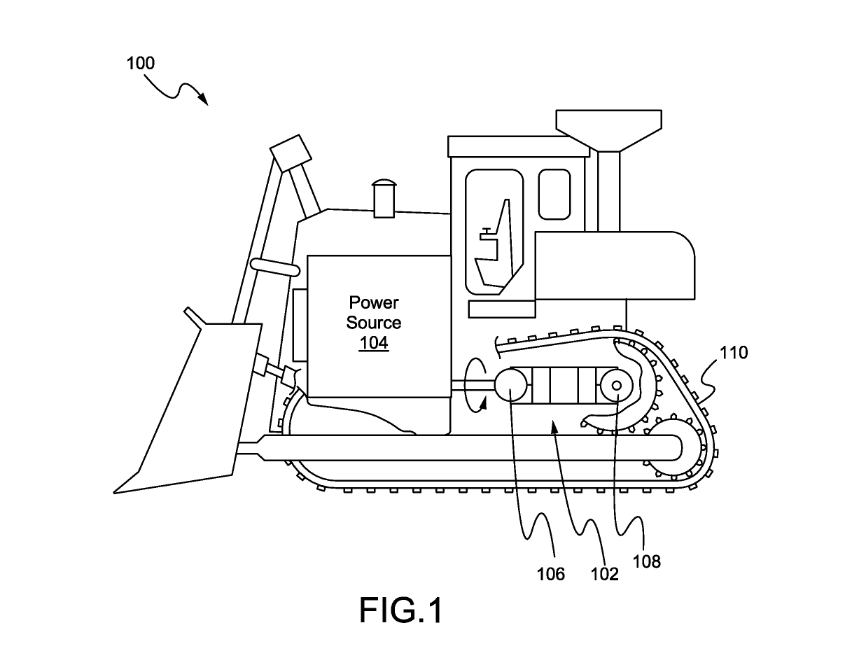

Referring to FIG. 1, one exemplary embodiment of a work machine 100 is illustrated with an electric drive 102 for generating electrical power from mechanical power or for generating mechanical power from electrical power. As shown, the work machine 100 includes a power source 104 that is mechanically coupled to an electric generator 106. The electric generator 106 may convert mechanical power supplied by the power source 104 into electrical power to be used by the electric drive 102. The electric drive 102 may also include an electric motor 108 that is mechanically coupled to one or more fraction devices 110 of the work machine 100. The electric motor 108 may convert electrical power supplied by the electric drive 102 into mechanical power for causing movement of the work machine 100 via the traction devices 110. In certain operating modes, such as during regenerative braking, the electric motor 108 may convert mechanical rotations received through the traction devices 110 into electrical power to be stored and/or used by the electric drive 102.

The power source 104 of FIG. 1 may include, for example, a combustion engine, such as a diesel engine, a gasoline engine, a natural gas engine, or the like. The work machine 100 may also be implemented using other types of power sources, such as batteries, fuel cells, and the like. The work machine 100 may be used in mobile applications for performing particular types of operations associated with an industry, such as mining, construction, farming, transportation, or any other suitable industry known in the art. The work machine 100 may include, for example, an earth moving machine, a marine vessel, an aircraft, a tractor, an off-road truck, an on-highway passenger vehicle, or the like. Furthermore, while the work machine 100 of FIG. 1 may be illustrated as being mobile, the work machine 100 may also be used to generate power in conjunction with stationary applications having, for instance, windmills, hydro-electric dams, or any other suitable means as a power source.

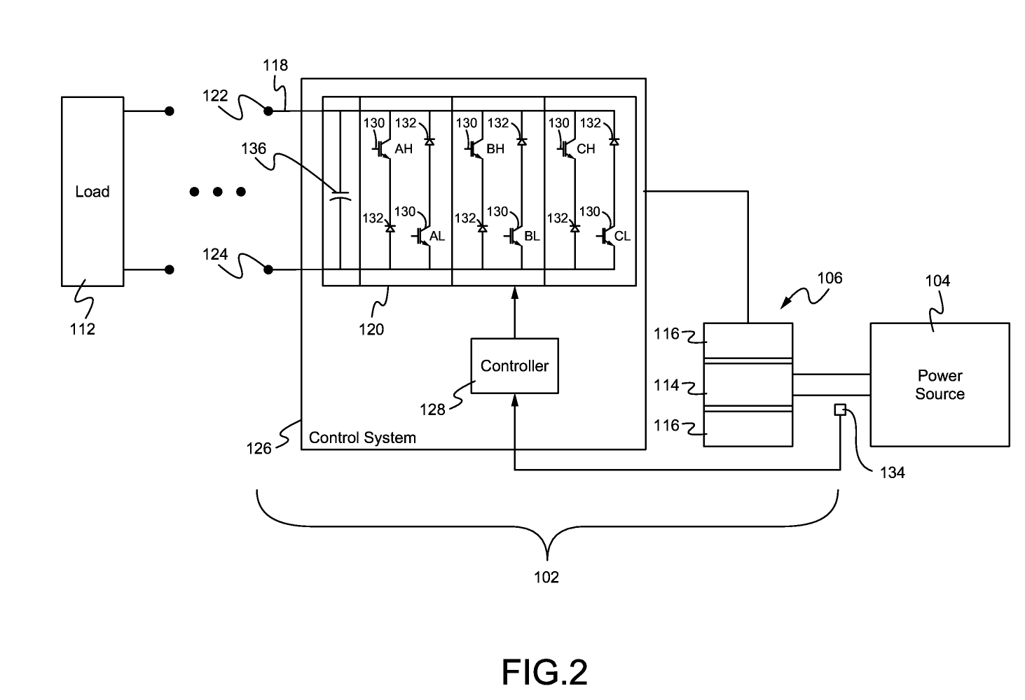

FIG. 2 schematically illustrates one exemplary electric drive 102 that can be used to communicate power between the power source 104 and one or more loads 112. The electric generator 106 of the electric drive 102 in FIG. 2 may be a switched reluctance generator, or the like, that is configured to produce electrical power in response to rotational input from the power source 104 and communicate the electrical power to the one or more loads 112 of the work machine 100. The loads 112 may include, for example, fractions motors for causing motion of the machine 100, pumps or actuators for operating machine tools, and any other electrically driven device or component associated with the work machine 100. As shown, the electric generator 106 includes a rotor 114 that is rotatably disposed within a fixed stator 116. The rotor 114 may be coupled to an output of the power source 104. The stator 116 may be electrically coupled to a common bus 118 of the electric drive 102 via a converter circuit 120.

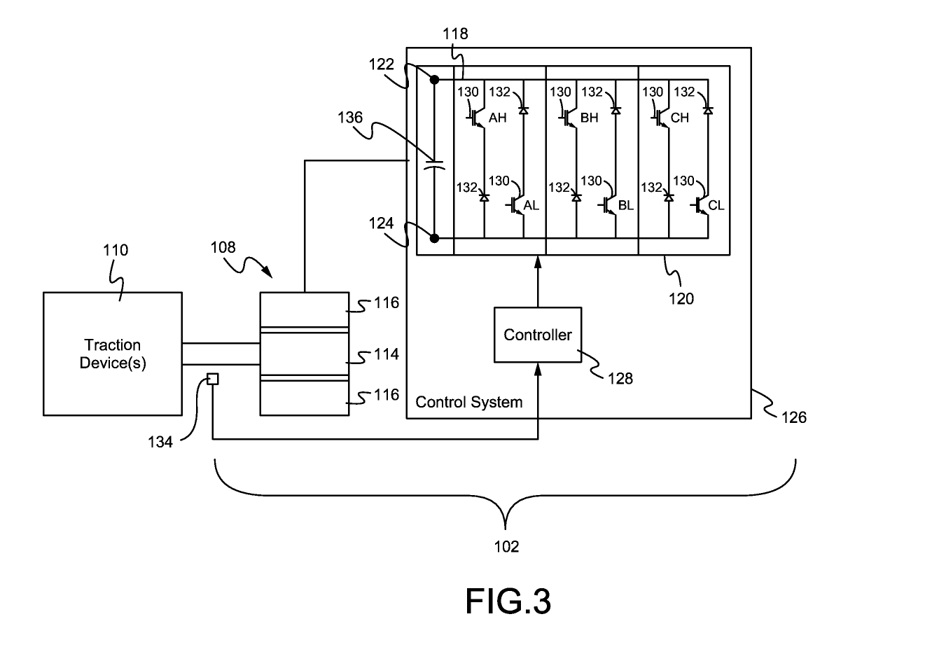

FIG. 3 schematically illustrates one exemplary electric drive 102 which communicates power between the converter circuit 120 and the electric motor 108. The electric motor 108 of the electric drive 102 may be a switched reluctance motor, or any other comparable motor capable of mechanically driving one or more traction devices 110 of the work machine 100 in response to electrical power received from the converter circuit 120. During regenerative braking modes of operation, or other low speed generating modes, the electric motor 108 may also generate and supply electrical power to the converter circuit 120 in response to rotational or otherwise mechanical input received from the traction devices 110. The electric motor 108 also includes a rotor 114 that is rotatably disposed within a fixed stator 116. The rotor 114 may be mechanically coupled to one or more of the traction devices 110, and the stator 116 may be electrically coupled to the converter circuit 120 via the common bus 118 of the electric drive 102.

Generally, during a generating mode of operation, the rotor 114 is mechanically rotated within the stator 116, which induces electrical current within the stator 116 that is further supplied to the converter circuit 120. The converter circuit 120 may in turn convert the electrical signals into an appropriate direct current (DC) voltage for distribution to any of the loads 112 of the work machine 100. During a motoring mode of operation, the rotor 114 is caused to rotate in response to electrical signals that are supplied to the stator 116 from the common bus 118. The common bus 118 may include a positive bus line 122 and a ground or negative bus line 124 across which a common DC bus voltage may be communicated to one or more loads 112 of the work machine 100. For instance, the converter circuit 120 may provide a DC signal to be transmitted through one or more rectifier circuits of the common bus 118 where the DC voltage may be converted into the appropriate alternating current (AC) signals for driving the electric motor 108 or any other load 112 requiring an AC supply voltage. The common bus 118 may also communicate the common DC voltage to other loads 112 of the work machine 100, such as to electrically driven pumps, fans, and the like.

The electric drive 102 of FIGS. 2 and 3 additionally includes a control system 126 for controlling the electric generator 106 and/or the electric motor 108. As shown, the control system 126 provides a controller 128 that is in communication with at least the converter circuit 120 of the electric drive 102. The converter circuit 120 also includes a series of transistors or gated switches 130, such as insulated-gate bipolar transistors, and associated diodes 132 for selectively enabling one or more phase windings of the respective stator 116 of the electric generator 106 and/or the electric motor 108. A three-phase switched reluctance machine, for example, may be provided with two switches 130, such as a first switch 130-1 and a second switch 130-2, and two diodes 132 for selectively enabling or disabling each of the three phase legs. Each switch 130 may be individually enabled or disabled via gate signals supplied by the controller 128.

As also shown in FIGS. 2 and 3, one or more sensors 134 may also be provided to generate a sensor signal corresponding to the angular position, displacement and/or speed of the rotor 114 relative to the stator 116, and communicate the sensor signal to an input of the controller 128. The sensors 134 may include encoders, Hall-effect sensors, variable reluctance sensors, anisotropic magnetoresistance sensors, or the like. Additionally, the control system 126 and the converter circuit 120 may be powered by an external or secondary power source, such as provided by a battery (not shown), residual voltage stored in a capacitor or ultracapacitor 136 of the common bus 118, or any other suitable current limited DC power supply.

The controller 128 in FIGS. 2 and 3 may be implemented using one or more of a processor, a microprocessor, a microcontroller, an electronic control module (ECM), an electronic control unit (ECU), and any other suitable means for providing electronic control to the electric generator 106 and/or the electric motor 108. The controller 128 may be configured to operate according to predetermined algorithms or sets of instructions designed to optimize performance based on observed characteristics of the electric drive 102. For example, the controller 128 can determine an optimal mode of operation for a given combination of observed operating speed, load characteristics and/or phase current requirements. Based on these parameters, the controller 128 may adjust the phase current supplied to each phase leg of the electric generator 106 or the electric motor 108, and operate according to any one of a single pulse mode, a current regulation mode, and the like. Additionally, the controller 128 may be configured to refer to predefined control maps or lookup tables which suggest the control scheme or routine most suited for a given situation. Such algorithms or sets of instructions for operating the electric generator 106 or the electric motor 108 may be preprogrammed or incorporated into a memory associated with the controller 128 by means commonly known in the art.

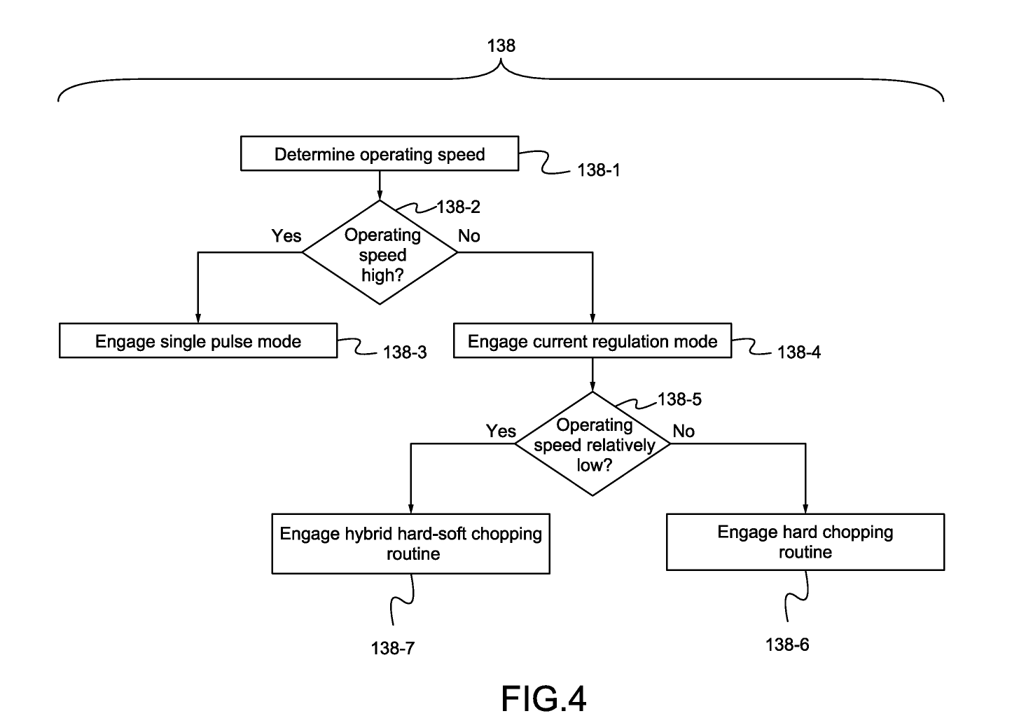

Referring now to FIG. 4, a flow diagram of an exemplary algorithm or method 138 by which the controller 128 may be configured to operate an electric generator 106 or an electric motor 108 is provided. In block 138-1, the controller 128 is configured to determine the operating speed of the electric generator 106 or the electric motor 108, and in block 138-2, the controller 128 compares the observed operating speed with one or more predefined thresholds or ranges of thresholds to determine if the operating speed is relatively high, nominal, or relatively low, as compared to a base speed. While the base speed for any particular application may vary, the base speed can be generally defined as the maximum speed at which the electric generator 106 or the electric motor 108 is able to output constant torque and before torque output begins to decrease proportionally with operating speed. Relatively low operating speeds may refer to speeds between zero and the approximate base speed, while relatively high operating speeds may refer to speeds exceeding the approximate base speed. Nominal operating speeds may refer to a range of speeds which approximate the base speed.

As shown in FIG. 4, if the operating speed is observed to be relatively high in block 138-2, the controller 128 may be configured to engage a single pulse mode of operation in block 138-3. During a single pulse mode of operation, the controller 128 may transmit gate signals configured to continuously enable or close both of the switches 130 of the converter circuit 120 associated with each phase leg of the respective stator 116 in a manner which sustains a substantially constant power range of output. Alternatively, if the controller 128 in block 138-2 determines that the operating speed is indicative of nominal speeds or relatively low speeds, the controller 128 may be configured to engage a current regulation mode of operating the electric generator 106 or the electric motor 108 according to block 138-4. Moreover, the controller 128 in block 138-5 may further distinguish between operating speeds that are nominal and relatively low, to determine whether to apply a hard chopping routine as in block 138-6 or a hybrid hard-soft chopping routine as in block 138-7.

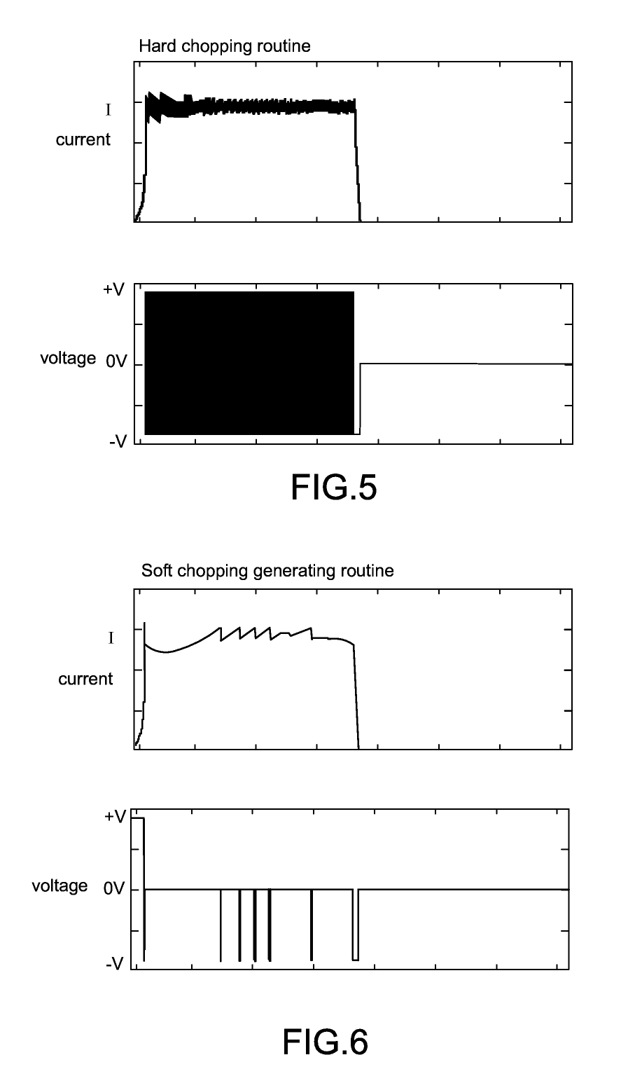

A hard chopping routine may generally not be applicable to the electric motor 108 of FIG. 3 due to the relatively low speeds with which the electric motor 108 would operate while in a generating mode. With respect to the electric generator 106 of FIG. 2, however, the controller 128 may engage a hard chopping routine in block 138-6 if the observed operating speed is nominal. While engaging the hard chopping routine, the controller 128 generates current through each phase leg of the electric generator 106 by simultaneously switching, such as opening or closing, both of the first switch 130-1 and the second switch 130-2 of each phase. As shown for example in FIG. 5, hard chopping may provide relatively constant average phase current. However, as also shown in FIG. 5, hard chopping involves switching the bus voltage between −V and +V at relatively high switching frequencies, which can exert significant stress on the converter circuit 120 if used for prolonged periods of time.

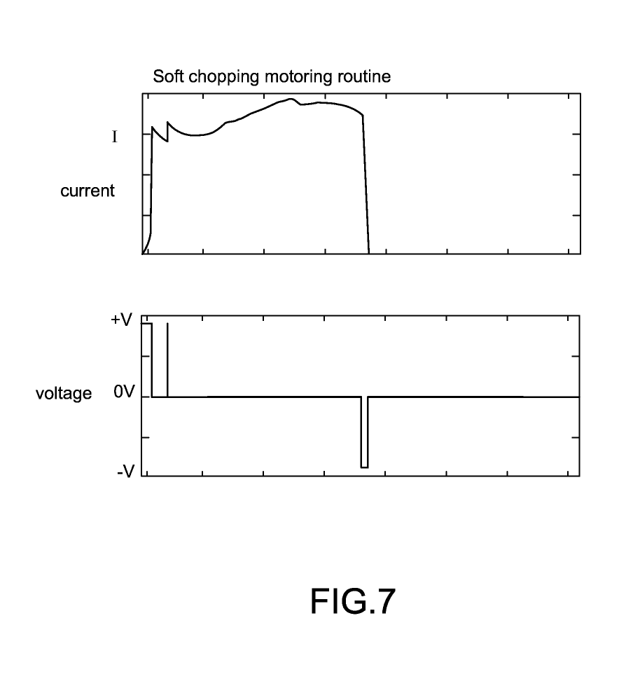

If the operating speed of the electric generator 106 or the electric motor 108 is relatively low, the controller 128 may be configured to engage a hybrid hard-soft chopping routine as in block 138-7. Generally, the hybrid hard-soft chopping routine engages the switches 130 according to a soft chopping routine, but temporarily resorts to the hard chopping routine as needed, for instance, if the phase current does not rise or decay as desired during the zero-voltage loop, or the period where the bus voltage is 0V. More specifically, depending on the operating mode of the electric generator 106 or the electric motor 108, the controller 128 in block 138-7 initially transmits gate signals which engage the switches 130 according to either a soft chopping generating routine as shown in FIG. 6 or a soft chopping motoring routine as shown in FIG. 7. In a soft chopping generating routine, the controller 128 holds the first switch 130-1 in the opened state while switching the second switch 130-2, thereby alternating the bus voltage between −V and 0V. In a soft chopping motoring routine, the controller 128 holds the first switch 130-1 in the closed state while switching the second switch 130-2, thereby alternating the bus voltage between +V and 0V. In alternative embodiments, the second switch 130-2 may be held in either the opened or the closed state while the first switch 130-1 is selectively switched.

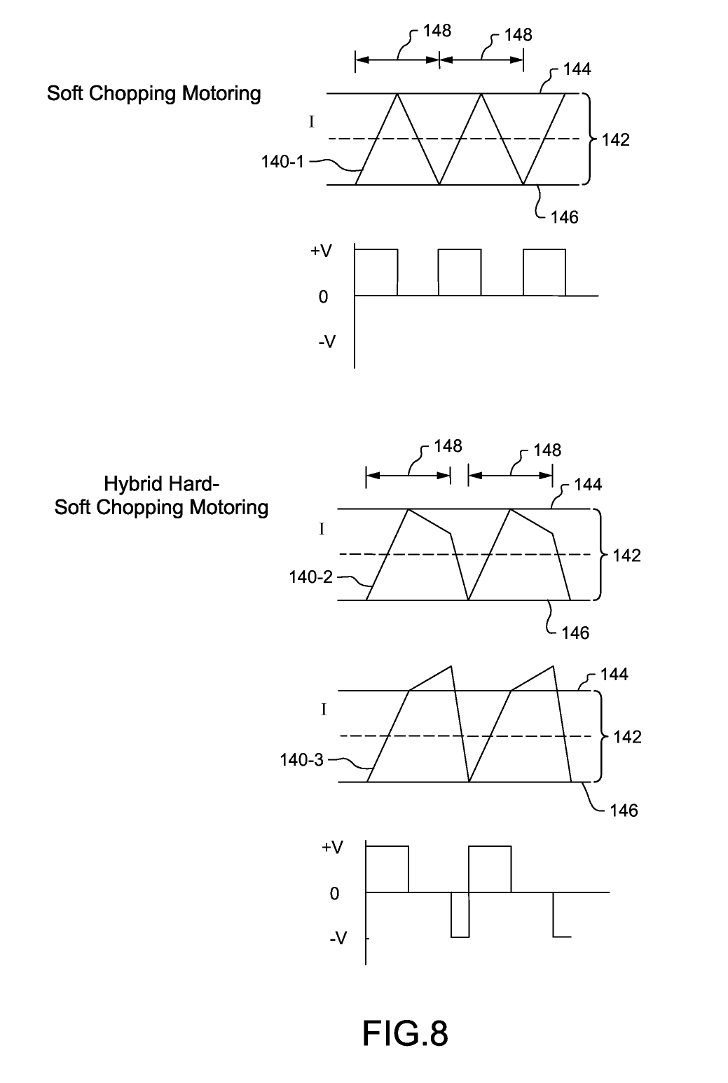

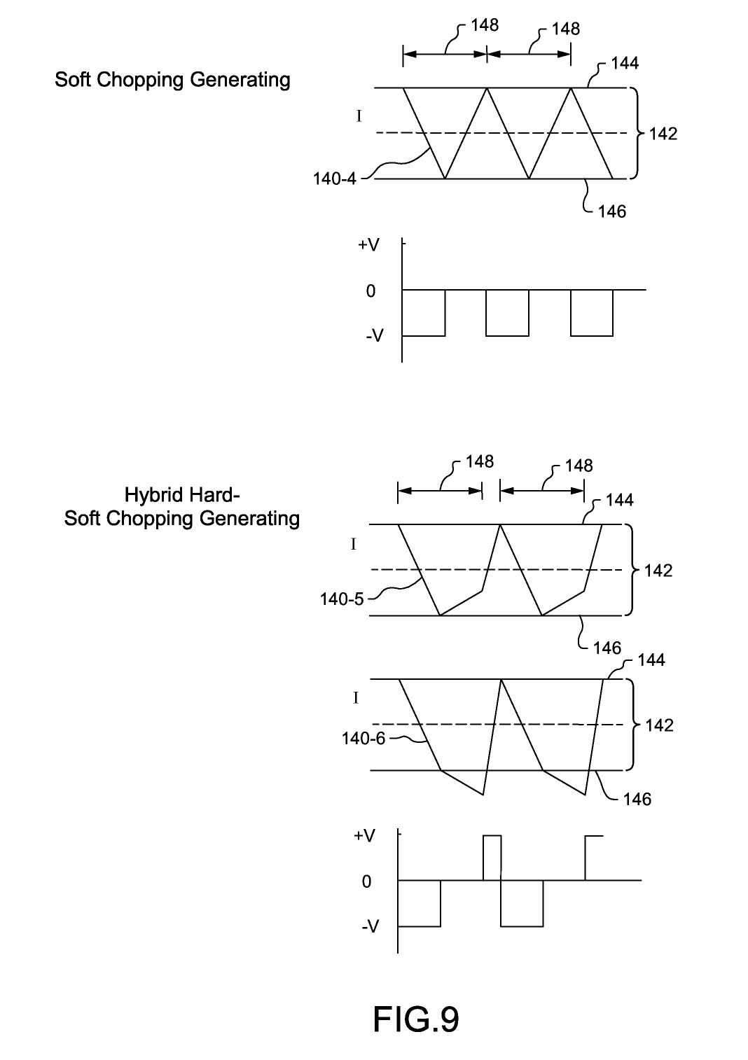

While engaging a soft chopping routine in block 138-7, and as shown for example in FIGS. 8 and 9, the controller 128 may monitor a phase current 140 relative to a hysteresis band 142 having an upper limit 144 and a lower limit 146, as well as a switching period 148 to determine if a hard chopping routine is applicable. If a soft chopping motoring routine is engaged as shown in FIG. 8, the controller 128 may determine whether the phase current 140 substantially reaches the lower limit 146 of the hysteresis band 142 before expiration of the given switching period 148. If the phase current 140 decays to the lower limit 146 within the switching period 148 as shown by signal 140-1, the controller 128 continues engaging the soft chopping motoring routine. If, however, the phase current 140 does not decay to the lower limit 146 within the switching period 148 as shown by signal 140-2, or rather increases as shown by signal 140-3 such as due to back-electromotive forces (BEMF), the controller 128 may temporarily engage the hard chopping routine to force the phase current 140 down to the lower limit 146.

For example, during a soft chopping motoring routine in which a first switch 130-1 is held closed while a second switch 130-2 is switched, engaging the hard chopping routine may open the first switch 130-1 such that both of the first switch 130-1 and the second switch 130-2 are held in the open state until the phase current 140 substantially reaches the lower limit 146. Once the phase current 140 substantially reaches the lower limit 146 of the hysteresis band 142, the controller 128 may close the first switch 130-1 and resume switching the second switch 130-2 according to the soft chopping motoring routine. Additionally, the controller 128 may be configured to restart counting or tracking of subsequent switching periods 148 from the point at which the soft chopping motoring routine is resumed. In this manner, the controller 128 may engage the hard chopping routine as necessary throughout the soft chopping motoring routine to help minimize deviations in the phase current 140 typically occurring during the zero-voltage or freewheeling states.

Correspondingly, if a soft chopping generating routine is engaged as shown in FIG. 9, the controller 128 may monitor the phase current 140 to determine if it substantially reaches the upper limit 144 of the hysteresis band 142 during the zero-voltage loop before expiration of the given switching period 148. If the phase current 140 substantially reaches the upper limit 144 within the switching period 148 as shown by signal 140-4, the controller 128 continues engaging the soft chopping generating routine. If, however, the phase current 140 does not reach the upper limit 144 within the switching period 148 as shown by signal 140-5, or rather decreases as shown by signal 140-6, the controller 128 may temporarily engage the hard chopping routine to force the phase current 140 up to the upper limit 144 as shown. During a soft chopping generating routine in which a first switch 130-1 is held open while a second switch 130-2 is switched, for example, engaging the hard chopping routine may close the first switch 130-1 such that both of the first switch 130-1 and the second switch 130-2 are held in the closed state until the phase current 140 substantially reaches the upper limit 144.

Once the phase current 140 substantially reaches or approximates the upper limit 144, the controller 128 may open the first switch 130-1 and resume switching the second switch 130-2 according to the soft chopping generating routine. In addition, the controller 128 may be configured to restart counting or tracking of subsequent switching periods 148 from the point at which the soft chopping generating routine is resumed. Again, in this manner, the controller 128 may engage the hard chopping routine as necessary throughout the soft chopping generating routine to help minimize deviations in the phase current 140 which typically occur during the zero-voltage or freewheeling states. It will be understood that FIGS. 8 and 9 are intended to be illustrative and are not necessarily drawn to scale. In other alternatives, the controller 128 may monitor the phase current 140 of FIGS. 8 and 9 immediately prior to the expiration of the switching period 148 and with time remaining sufficient to allow for adjustments to the phase current 140 before entering a subsequent switching period 148.

Furthermore, the hybrid hard-soft chopping routines may additionally be applicable to transitions between motoring and generating modes of operation of the electric drive 102. More particularly, in a transition between motoring and generating modes of operation, such as during a freewheeling state, the phase current 140 may be subject to unwanted deviations. Enabling hybrid hard-soft chopping routines to perform during such transitions enables the hard chopping routine to correct for deviations in the phase current 140 as necessary. Thus, by configuring the hybrid hard-soft chopping motoring routine and/or the hybrid hard-soft chopping generating routine to at least partially encompass both motoring and generating modes of operation of the electric drive 102, rather than being limited to a single mode of operation, transitions between motoring and generating modes of operation can also benefit from the hybrid hard-soft chopping routines.

Other variations and modifications will be apparent to those of ordinary skill in the art. Exemplary algorithms or methods by which the controller 128 may be operated to regulate current in a switched reluctance machine is discussed in more detail below.

### INDUSTRIAL APPLICABILITY

In general, the present disclosure finds utility in various industrial applications, such as construction, mining and farming industries. Specifically, the disclosed systems and methods provide current regulation control schemes for electric generators and electric motors, such as switched reluctance machines, which are commonly used in association with work machines and/or vehicles, such as tractors, backhoe loaders, compactors, feller bunchers, forest machines, industrial loaders, skid steer loaders, wheel loaders, and the like. Moreover, by operating the switched reluctance machines according to hybrid hard-soft chopping routines, the present disclosure allows reliable operation and adequate control using lower switching frequencies and exhibits lower losses overall. Furthermore, by enabling operations at lower switching frequencies, the present disclosure exerts less stress on the converter circuit and enables longer operation of switched reluctance machines in current regulation modes at low speeds.

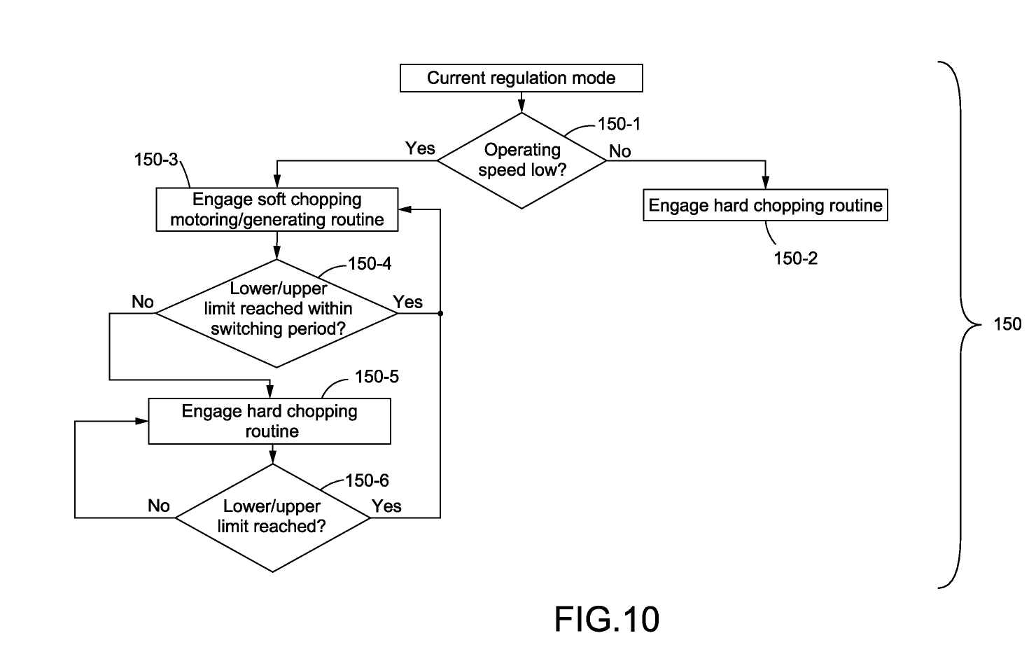

Turning now to FIG. 10, one exemplary algorithm or controller-implemented method 150 of regulating phase current 140 of an electric generator 106 or an electric motor 108, such as a switched reluctance machine, is diagrammatically provided. As shown, the controller 128 according to block 150-1 may be configured to monitor the operating speed to determine whether to apply a hard chopping routine or a hybrid hard-soft chopping routine. For example, if the operating speed is nominal, the controller 128 may engage a hard chopping routine according to block 150-2, or by simultaneously opening and closing both of the first switch 130-1 and the second switch 130-2 of each phase until the average target phase current is achieved. If the operating speed is relatively low, the controller 128 may proceed to engage a hybrid hard-soft chopping routine, or a combination of a soft chopping routine and a hard chopping routine as graphically illustrated for example in FIGS. 8 and 9.

According to block 150-3 of FIG. 10, the controller 128 may be configured to initially engage a soft chopping routine to perform low speed current regulation. Specifically, depending on the operating mode of the electric generator 106 or electric motor 108, the controller 128 may engage either a soft chopping motoring routine or a soft chopping generating routine. A soft chopping generating routine may configure the controller 128 to hold the first switch 130-1 of each phase in the closed state while switching the second switch 130-2 between the opened and closed states, thereby alternating the bus voltage of the converter circuit 120 to provide a zero-voltage loop between 0V and +V. Correspondingly, a soft chopping motoring routine may configure the controller 128 to hold the first switch 130-1 of each phase in the opened state while switching the second switch 130-2 between the opened and closed states, thereby alternating the bus voltage of the converter circuit 120 to provide a zero-voltage loop between 0V and −V. In alternative embodiments, the controller 128 may hold the second switch 130-2 of each phase in either the opened state or the closed state while selectively switching the first switch 130-1.

In block 150-4 of FIG. 10, and while a soft chopping routine is being performed according to block 150-3, the controller 128 may monitor the resulting phase current 140, at least relative to a hysteresis band 142 and a switching period 148, to determine when a hard chopping routine should be applied if at all. As shown in FIG. 8, for example, if a soft chopping motoring routine is being performed, the controller 128 monitors the phase current 140 to determine whether the phase current 140 decays to the lower limit 146 of the hysteresis band 142 during the zero-voltage loop before expiration of the given switching period 148. If the phase current 140 substantially decays to the lower limit 146 within the switching period 148, the controller 128 continues engaging the soft chopping motoring routine according to block 150-3. If, however, the phase current 140 does not decay to the lower limit 146 within the switching period 148, the controller 128 in block 150-5 engages a hard chopping routine, or holds both switches 130 in the open state as illustrated in FIG. 8. The controller 128 in block 150-6 may additionally continue monitoring the phase current 140 to determine if the phase current 140 substantially reaches the lower limit 146. Once the phase current 140 reaches or approximates the lower limit 146, the controller 128 may resume the soft chopping motoring routine according to block 150-3. Otherwise, the controller 128 may continue engaging the hard chopping routine, or holds both switches 130 in the open state.

Alternatively, as shown in FIG. 9, for example, if a soft chopping generating routine is performed in block 150-3, the controller 128 monitors the phase current 140 to determine whether the phase current 140 substantially reaches the upper limit 144 of the hysteresis band 142 during the zero-voltage loop before expiration of the given switching period 148. If the phase current 140 approximates the upper limit 144 within the switching period 148, the controller 128 continues engaging the soft chopping generating routine according to block 150-3. If, however, the phase current 140 does not substantially reach the upper limit 144 within the switching period 148, the controller 128 in block 150-5 engages the hard chopping routine and holds both switches 130 in the closed state as illustrated in FIG. 9. The controller 128 in block 150-6 may additionally continue monitoring the phase current 140 to determine if the phase current 140 substantially reaches the upper limit 144. Once the phase current 140 reaches or approximates the upper limit 144, the controller 128 may resume the soft chopping generating routine according to block 150-3. Otherwise, the controller 128 may continue engaging the hard chopping routine by holding both switches 130 in the closed state until at least the desired phase current 140 is achieved.

The controller 128 may continue employing such hybrid hard-soft chopping routines, such as reiteratively alternating between the soft chopping and hard chopping routines, so long as the operating speed of the electric generator 106 or the electric motor 108 as determined in block 150-1 remains relatively low, and so long as the current regulation mode of operation is maintained. For example, if the operating speed reaches nominal speeds at any time, the controller 128 may cease the hybrid hard-soft chopping routines and engage a standard hard chopping routine according to block 150-2. Additionally, if the operating speed reaches relatively high speeds at any time, such as determined by block 138-2 of FIG. 4, the controller 128 may cease operating in the current regulation mode and engage a single pulse mode of operation as in block 138-3 of FIG. 4. Furthermore, the controller 128 may apply hybrid hard-soft chopping routines to transitions between motoring and generating modes of operation to correct for any unwanted deviations in the phase current 140 which occur during a freewheeling state thereof.

From the foregoing, it will be appreciated that while only certain embodiments have been set forth for the purposes of illustration, alternatives and modifications will be apparent from the above description to those skilled in the art. These and other alternatives are considered equivalents and within the spirit and scope of this disclosure and the appended claims.

What is claimed is:

1. A method of regulating a phase current of an electric motor, comprising:
selectively enabling one or more switches of each phase of the electric motor according to one of at least a soft chopping motoring routine and a soft chopping generating routine;
monitoring the phase current relative to at least one limit of a hysteresis band and a switching period; and
controlling the switches according to a hard chopping routine when the phase current does not reach the limit within the switching period.

2. The method of claim 1, wherein the electric motor is a switched reluctance motor operating at relatively low speeds.

3. The method of claim 1, wherein each phase of the electric motor includes a first switch and a second switch, the first switch being continuously enabled while the second switch is selectively enabled according to the soft chopping motoring routine, the first switch being continuously disabled while the second switch is selectively enabled according to the soft chopping generating routine, and both of the first switch and the second switch being held in one of an enabled state and a disabled state according to the hard chopping routine.

4. The method of claim 1, wherein the switches are controlled according to the hard chopping routine and held in one of an enabled state and a disabled state until the phase current reaches the corresponding limit.

5. The method of claim 4, wherein the switches are enabled according to one of the soft chopping motoring routine and the soft chopping generating routine once the phase current reaches the corresponding limit.

6. The method of claim 1, wherein the hysteresis band includes an upper limit and a lower limit, the phase current being monitored relative to the upper limit during the soft chopping generating routine, and the phase current being monitored relative to the lower limit during the soft chopping motoring routine.

7. The method of claim 6, wherein the switches are controlled according to the hard chopping routine when the phase current does not reach the upper limit within the switching period while performing the soft chopping generating routine, the hard chopping routine being engaged until the phase current reaches the upper limit, the soft chopping generating routine being resumed once the phase current reaches the upper limit.

8. The method of claim 6, wherein the switches are controlled according to the hard chopping routine when the phase current does not reach the lower limit within the switching period while performing the soft chopping motoring routine, the hard chopping routine being engaged until the phase current reaches the lower limit, the soft chopping motoring routine being resumed once the phase current reaches the lower limit.

9. A control system for regulating a phase current of an electric motor, comprising:
a converter circuit operatively coupled to a stator of the electric motor, the converter circuit including one or more switches coupled to each phase of the stator; and
a controller in communication with each of the electric motor and the converter circuit, the controller being configured to enable the switches of each phase of the stator according to one of at least a soft chopping motoring routine and a soft chopping generating routine, monitor the phase current relative to at least one limit of a hysteresis band and a switching period, and control the switches according to a hard chopping routine when the phase current does not reach the limit within the switching period.

10. The control system of claim 9, wherein the electric motor is a switched reluctance motor operating at relatively low speeds.

11. The control system of claim 9, wherein the converter circuit includes a first switch and a second switch coupled to each phase of the stator, the soft chopping motoring routine configuring the controller to continuously enable the first switch while selectively enabling the second switch, the soft chopping generating routine configuring the controller to continuously disable the first switch while selectively enabling the second switch, and the hard chopping routine configuring the controller to simultaneously hold both of the first switch and the second switch in one of an enabled state and a disabled state.

12. The control system of claim 9, wherein the controller is configured to engage the hard chopping routine until the phase current reaches the corresponding limit, and resume one of the soft chopping motoring routine and the soft chopping generating routine once the phase current reaches the corresponding limit.

13. The control system of claim 9, wherein the hysteresis band includes an upper limit and a lower limit, the controller being configured to monitor the phase current relative to the upper limit during the soft chopping generating routine, and monitor the phase current relative to the lower limit during the soft chopping motoring routine.

14. The control system of claim 13, wherein the controller is configured to engage the hard chopping routine when the phase current does not reach the upper limit within the switching period while performing the soft chopping generating routine, the controller being configured to engage the hard chopping routine until the phase current reaches the upper limit, and resume the soft chopping generating routine once the phase current reaches the upper limit.

15. The control system of claim 13, wherein the controller is configured to engage the hard chopping routine when the phase current does not reach the lower limit within the switching period while performing the soft chopping motoring routine, the controller being configured to engage the hard chopping routine until the phase current reaches the lower limit, and resume the soft chopping motoring routine once the phase current reaches the lower limit.

16. An electric drive, comprising:
an electric motor having a rotor and a stator;
a converter circuit in communication with the stator, the converter circuit including at least a first switch and a second switch coupled to each phase of the stator; and
a controller in communication with each of the stator and the converter circuit, the controller being configured to enable the first switch and the second switch according to one of at least a soft chopping motoring routine and a soft chopping generating routine, monitor the phase current relative to at least one limit of a hysteresis band and a switching period, and control the first switch and the second switch according to a hard chopping routine when the phase current does not reach the limit within the switching period.

17. The electric drive of claim 16, wherein the electric motor is a switched reluctance motor operating at relatively low speeds.

18. The electric drive of claim 16, wherein the hysteresis band includes an upper limit and a lower limit, the controller being configured to monitor the phase current relative to the upper limit during the soft chopping generating routine, and monitor the phase current relative to the lower limit during the soft chopping motoring routine.

19. The electric drive of claim 18, wherein the controller is configured to engage the hard chopping routine when the phase current does not reach the upper limit within the switching period while performing the soft chopping generating routine, the controller being configured to engage the hard chopping routine until the phase current reaches the upper limit, and resume the soft chopping generating routine once the phase current reaches the upper limit.

20. The electric drive of claim 18, wherein the controller is configured to engage the hard chopping routine when the phase current does not reach the lower limit within the switching period while performing the soft chopping motoring routine, the controller being configured to engage the hard chopping routine until the phase current reaches the lower limit, and resume the soft chopping motoring routine once the phase current reaches the lower limit.
